(19) United States
(12) Patent Application Publication
(10) Pub. No.: US 2014/0195077 A1
(43) Pub. Date: Jul. 10, 2014

(54) Systems and Methods for Runway Condition Alert and Warning

(71) Applicant: Trond Are Johnsen, Drammen (NO)

(72) Inventor: Trond Are Johnsen, Drammen (NO)

(21) Appl. No.: 13/737,019

(22) Filed: Jan. 9, 2013

(51) Int. Cl. B64D 45/04

(52) U.S. Cl. CPC B64D 45/04
USPC 701/16

(57) ABSTRACT

Systems and methods for runway condition alert and warning. The system can include a first measurement system disposed on a first aircraft, the first measurement system adapted to gather telemetry inputs associated with a braking action value of the first aircraft on an airport runway. The system can also include a second measurement system disposed on a second aircraft, the second measurement system adapted to gather telemetry inputs associated with a braking action value of the second aircraft on the airport runway. The system can also include a computer adapted to receive and sort the telemetry inputs from the first and second aircraft. The computer can be adapted to utilize the telemetry inputs to predict an expected future braking action value for a third aircraft scheduled to utilize the airport runway.

### BACKGROUND

1. Field

Embodiments described herein generally relate to systems and methods for determining operational conditions and usage parameters for airport runways.

2. Description of the Related Art

Aircraft braking capability or braking action, as it is frequently termed, is a measure of how an aircraft can decelerate on a runway. The braking action for a particular airport runway is utilized by aircraft operators, dispatchers, and air traffic controllers to plan aircraft and airport operations. However, none of the traditionally used equipment such as trailer based friction equipment, however, has proven to have a direct correlation to the braking and stopping of an aircraft.

Aircraft braking action is a function of a multitude of factors including weather, weather contaminants (such as snow, ice, rain, etc.), runway surface condition, and aircraft configuration including weight, landing speed, and takeoff speed. Today, determining and communicating braking action is done in quantitative and qualitative ways. Friction measurement equipment produces the typical quantitative information, whereas verbal descriptions of runway contaminants and their extent and pilot reporting about their assessment of their landings are qualitative methods. Both methods have drawbacks. Friction measurements are normally performed by closing a runway and utilizing a mechanical friction measurement device on the runway to determine a measure of the braking action. The resulting information is normally verbally relayed to air traffic controllers. Subjective observations are also verbally communicated to controllers. Apart from the subjectivity of qualitative descriptions and the lack of correlation between friction measurement and the braking/stopping process of an aircraft, this type of information can be quickly outdated due to changing weather conditions.

The NTSB has proposed in their work with the federal aviation administration (FAA) the need for new ways to assess braking action. The Flight Safety Foundation has expressed their concerns in their Runway Safety Initiative (RSI) and Runway Excursion Risk Reduction (RERR) Tool kit,

### SUMMARY

Systems and methods for runway condition alert and warning. In at least one specific embodiment, the system can include a first measurement system disposed on a first aircraft, the first measurement system adapted to gather telemetry inputs associated with a braking action value of the first aircraft on an airport runway. The system can also include a second measurement system disposed on a second aircraft, the second measurement system adapted to gather telemetry inputs associated with a braking action value of the second aircraft on the airport runway. The system can also include a computer adapted to receive and sort the telemetry inputs from the first and second aircraft. The computer can be adapted to utilize the telemetry inputs to predict an expected future braking action value for a third aircraft scheduled to utilize the airport runway and to selectively transmit, to a communication device, an alert notification if at least one alert threshold is met and a warning notification if at least one warning threshold is met. The computer can also be adapted to utilize a first data smoothing factor and a first trend smoothing factor to predict the expected future braking action value.

In at least one specific embodiment, the method for communication of an airport runway condition can include comparing a first aircraft braking action value, for an airport runway, determined from a first telemetry input from a first aircraft, to a braking action alert threshold and a braking action warning threshold. An alert notification can be selectively transmitted to a communications device if the first aircraft braking action value meets or exceeds the braking action alert threshold. A warning notification can be selectively transmitted to the communications device if the first aircraft braking action value meets or exceeds the braking action warning threshold. An expected future braking action value for the airport runway based on the first telemetry input from the first aircraft and a second telemetry input from a second aircraft can be predicted. The alert notification can be selectively transmitted to the communications device if the expected future braking action value meets or exceeds the braking action alert threshold. The warning notification can be selectively transmitted to the communications device if the expected future braking action value meets or exceeds the braking action warning threshold.

In at least one specific embodiment, the method for an aircraft operational monitoring system can include searching one or more flight records for one or more destination airports and one or more alert or warning notifications associated with one or more runway identifiers. One or more flight records containing a match between the destination airport and the one or more runway identifiers can be selected. The selected one or more flight records can be updated with an alert or warning notification in a field of each of the selected one or more flight records. One or more updated selected flight records can be transmitted to a user application. The alert or warning notification can be selectively displayed to users by associating the alert or warning notification with aircraft having planned landings at the destination airport.

### BRIEF DESCRIPTION OF THE DRAWINGS

FIG. 1 depicts a schematic of an illustrative system for predicting aircraft braking action values and selectively distributing one or more alert and/or warning notifications to one or more aircraft, airline operators, dispatchers, and/or controllers, according to one or more embodiments described.

FIG. 2 depicts an illustrative data handling and processing system for predicting aircraft braking action values and for selectively distributing one or more alert and/or warning notifications, according to one or more embodiments described.

FIG. 3 depicts an illustrative flow diagram for predicting one or more braking action values and assessing alert and warning conditions for one or more airport runways, according to one or more embodiments described.

FIG. 4 depicts a schematic of an illustrative flight landing-plan for an aircraft in flight, according to one or more embodiments described.

FIG. 5 depicts an illustrative flow diagram for aircraft landing, planning, and decision, according to one or more embodiments described.

### DETAILED DESCRIPTION

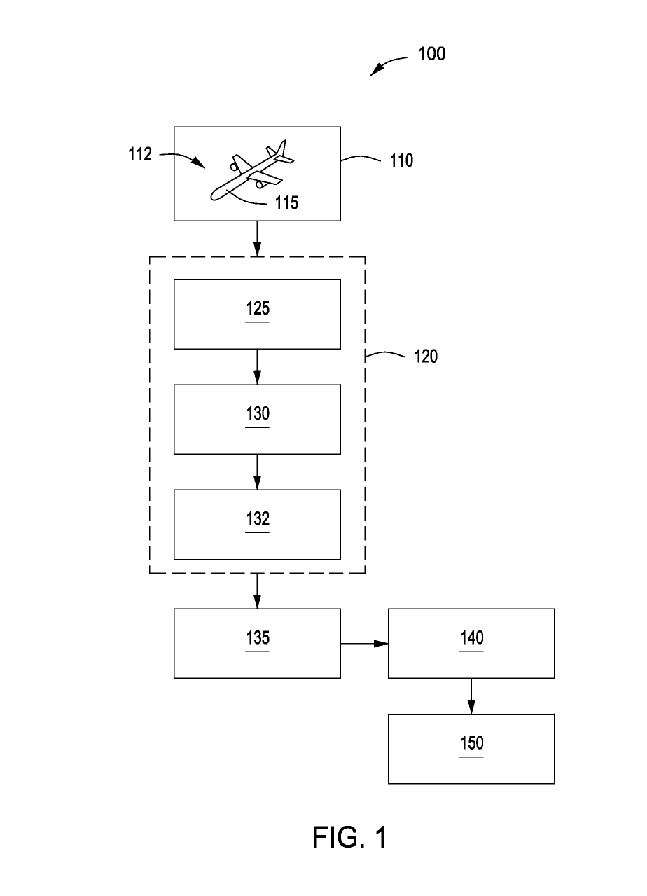

FIG. 1 depicts a schematic of an illustrative system 100 for predicting aircraft braking action values and selectively distributing one or more alert and/or warning notifications to one or more aircraft, airline operators, dispatchers, pilots, controllers, and/or other users, according to one or more embodiments. The systems and methods for predicting aircraft braking action discussed and described herein can form part of an information system, not shown, for providing aeronautical information to airline operators and controllers.

Aircraft telemetry data 110 can be collected by one or more known measurement systems 115 disposed on one or more aircraft 112. For example, a first measurement system 115 can be disposed on a first aircraft 112 and a second measurement system 115 can be disposed on a second aircraft 112. The aircraft telemetry data 110 can be used as one or more telemetry inputs for determining aircraft braking action values and can be automatically and/or selectively transferred to one or more other aircraft, one or more operators, one or more dispatchers, one or more controllers, and/or one or more other users 135. Aircraft braking action values can be related to “g-force” or deceleration on the one or more aircraft 112 during runway braking and can be adjusted for constituents contributing to the deceleration that are attributable to non-pavement sources. The ability of an aircraft to brake and stop in situations that are friction limited, i.e., the condition where increased brake pressure will not lead to increased deceleration, can be defined as the maximum braking action and the corresponding g-force at this/these point(s) can be defined as the “braking action value.” In one or more embodiments, the g-force or deceleration rate can serve as the foundation for the one or more telemetry inputs used.

U.S. Pat. No. 7,941,261 describes methods and systems for a self-adjusting braking energy force application that can apply the appropriate braking force to an aircraft tire to slow an aircraft and, in combination with the measured braking action telemetry data and deceleration telemetry data gathered by a measurement system on-board the aircraft during runway braking, can be analyzed to determine aircraft braking action values. U.S. Pat. No. 8,121,771 describes ground based methods and apparatus for calculating braking action values using a recorded telemetry data stream of data gathered by a measurement system on-board an aircraft plus weather and environmental factors, together with known performance and design parameters of the aircraft.

Continuing with reference to FIG. 1, the aircraft telemetry data 110 can be received and transmitted to one or more data handling and processing systems 120. The one or more data handling and processing systems 120 can include one or more computers (not shown). The one or more computers can include at least one data server and database agent 132. At least one braking action prediction/alert/warning agent 125 can be run on the one or more computers. The one or more data handling and processing systems 120 can receive, store, process, sort, and/or transmit the aircraft telemetry data 110, braking action related information, alert notifications, and/or warning notification to the one or more other aircraft, one or more operators, one or more dispatchers, one or more controllers, and/or one or more other users 135. The one or more other aircraft, one or more operators, one or more dispatchers, one or more controllers, and/or one or more other users 135 can utilize the aircraft telemetry data 110, braking action related information, alert notifications, and/or warning notification to develop one or more flight landing-plans 140. The one or more flight landing-plans 140 can be developed utilizing an in flight aircraft landing, planning, and decision flow 150.

There are general aeronautical terms known in the art to describe braking action such as “medium,” “poor,” and “nil,” which provide an indication of the runway conditions impacts on stopping distances and/or of reduced friction on a runway that may impact an aircraft's crosswind limits. Aircraft manufacturers such as Boeing and Airbus define various levels of braking action into certain numeric thresholds for their aircraft. A runway warning condition can be declared and the warning notification can be transmitted when the aircraft braking action value breaks the numeric threshold for “medium.” A runway alert condition can be declared and the alert notification can be transmitted when an aircraft braking action value breaks the numeric threshold for “poor.” A notification can also be sent for a “nil” condition.

It has been discovered that future braking action values can be predicted from aircraft telemetry data 110 and/or aircraft braking action values from aircraft that have already landed on a runway by utilizing double exponential smoothing techniques, at least one method of which is described below. The braking action prediction/alert/warning agent 125 can utilize double exponential smoothing techniques to generate the future braking action value predictions. Information can be selectively transmitted to one or more aircraft, airline operators, dispatchers, and/or controllers via data links and computerized communication processes not shown but known in the art. The information can be sorted into at least one alert notification and/or at least one warning notification and the at least one alert notification and/or the at least one warning notification can be associated with at least one aircraft that is then scheduled to land on the associated airport runway for which a predicted future braking action value has been generated. The alert and/or warning notification can be selectively transmitted to other aircraft, operators, dispatchers, controllers, and/or other users and selectively associated with the aircraft that are then scheduled to land on the runway or runways having the alert or warning condition or conditions.

Where airline operators fit their aircraft with apparatus that can transmit braking action related telemetry data, for example g-force (deceleration rate), major airports and typical hubs can have from a low of about 10, 20, 30, 40, or 60 to a high of about 100, 200, 300, 400, or 600 or more aircraft landings and, therefore, aircraft telemetry data sources per day. In addition to the number of times quantitative information can be provided per day for an airport/runway, the system 100 can distinguish changes in and/or deterioration of runway conditions, typically seen when weather fronts are moving in and out. The system 100 can also predict or estimate future braking action values for transmission to one or more users and for predicting alert and/or warning conditions. Aircraft servicing numerous airports through their route network can generate braking action values at various airports.

The system 100 can use the telemetry data from one or more aircraft providing up to nearly continuous information within a network of airports and runways. A typical day could yield between about 10 to more than 12,000 aircraft telemetry input sources from aircraft servicing many different airports. Whereas major airlines typically have the operational function of dispatch as a central function located in one or more locations, they tend to have their flight planning and dispatch tool co-located. A dispatcher has an active role in short term planning of take off, en route, and landing phases of a flight, where he/she will monitor the flight. Weather situations at destinations and alternate airports are one of the factors that a dispatcher evaluates. Currently there are a few applications that serve as tools for dispatchers to do their work. These dispatcher applications are typically web based systems that can provide real time flight tracking and access to all public aeronautical weather information as well as special information, such as turbulence, thunder storms, lightening, etc., that could be of proprietary nature for the system providers. A typical dispatcher will monitor one or several flights from a monitor that he/she can access through a graphical user interface. The graphical user interface can be a representation of a map where aircraft in flight are depicted as small icons. Related flight tracks and status can be superimposed on the maps. Icons can also display various types of pertinent flight information if the user selects or rolls over the icon with a cursor.

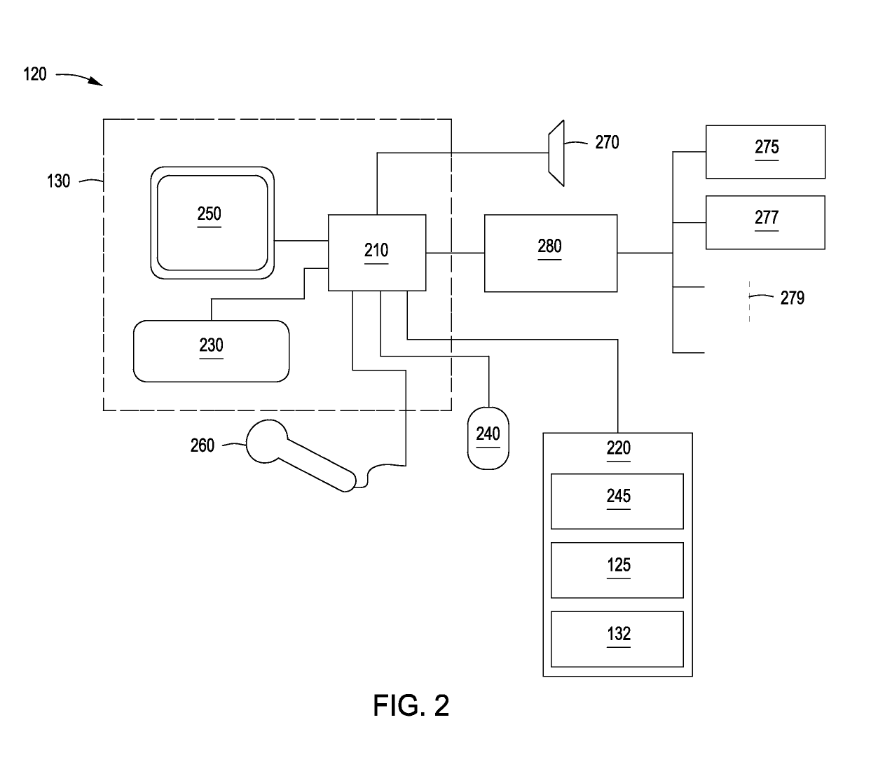

FIG. 2 depicts an illustrative one or more data handling and processing systems 120 for predicting aircraft braking action values and for selectively distributing one or more alert and/or warning notifications, according to one or more embodiments. The system 120 can include one or more computers 130 that can include one or more central processing units 210, one or more input devices or keyboards 230, and one or more output devices 250 on which a software application can be executed. The one or more computers 130 can also include one or more memories 220 as well as additional input and output devices, for example a mouse 240, one or more microphones 260, and one or more speakers 270. The mouse 240, the one or more microphones 260, and the one or more speakers 270 can be used for, among other purposes, universal access and voice recognition or commanding. The one or more output devices 250 can be touch-sensitive to operate as an input device as well as a display device.

The one or more computers 130 can interface with database 277, support computer or processor 275, other databases and/or other processors 279, or the Internet via the interface 280. It should be understood that the term “interface” does not indicate a limitation to interfaces that use only Ethernet connections and refers to all possible external interfaces, wired or wireless. It should also be understood that database 277, processor 275, and/or other databases and/or other processors 279 are not limited to interfacing with the one or more computers 130 using network interface 280 and can interface with one or more computers 130 in any means sufficient to create a communications path between the one or more computers 130 and database 277, processor 275, and/or other databases and/or other processors 279. For example, in one or more embodiments, database 277 can interface with one or more computers 130 via a USB interface while processor 275 can interface via some other high-speed data bus without using the network interface 280. The one or more computers 130, the processor 275, and the other processors 279 can be integrated into a multiprocessor distributed system.

It should be understood that even though the one or more computers 130 is shown in FIG. 2 as a platform on which the methods discussed and described herein can be performed, the methods discussed and described herein could be performed on any platform. For example, the many and varied embodiments discussed and described herein can be used on any device that has computing capability. For example, the computing capability can include the capability to access communications bus protocols such that the user can interact with the many and varied computers 130, processors 275, and/or other databases and processors 279 that can be distributed or otherwise assembled. These devices can include, but are not limited to, supercomputers, arrayed server networks, arrayed memory networks, arrayed computer networks, distributed server networks, distributed memory networks, distributed computer networks, desktop personal computers (PCs), tablet PCs, hand held PCs, laptops, devices sold under the trademark names BLACKBERRY™ or PALM™, cellular phones, hand held music players, or any other device or system having computing capabilities.

Still referring to FIG. 2, programs can be stored in the one or more memories 220 and the one or more central processing units 210 can work in concert with at least the one or more memories 220, the one or more input devices 230, and the one or more output devices 250 to perform tasks for the user. In one or more embodiments, the one or more memories 220 can include any number and combination of memory devices, without limitation, as is currently available or can become available in the art. In one or more embodiments, memory devices can include without limitation, and for illustrative purposes only: database 277, other databases and/or processors 279, hard drives, disk drives, random access memory, read only memory, electronically erasable programmable read only memory, flash memory, thumb drive memory, and any other memory device. Those skilled in the art are familiar with the many variations that can be employed using memory devices and no limitations should be imposed on the embodiments herein due to memory device configurations and/or algorithm prosecution techniques.

The one or more memories 220 can store an operating system (OS) 245, the braking action prediction/alert/warning agent 125, and a database agent 132. The operating system 245 can facilitate control and execution of software using the one or more central processing units 210. Any available operating system can be used in this manner including WINDOWS™, LINUX™, Apple OS™, UNIX™, and the like.

The one or more central processing units 210 can execute either from a user request or automatically. In one or more embodiments, the one or more central processing units 210 can execute the braking action prediction/alert/warning agent 125 and/or the database agent 132 when a user requests, among other requests, to predict a future expected braking action value for an aircraft that is then scheduled to land on a given airport runway.

It should be noted that the braking action prediction/alert/warning agent 125 and the database agent 132 can be fully autonomous code sets, partially integrated code sets, or fully integrated code sets and no limitations should be construed from the depiction of the braking action prediction/alert/warning agent 125 and the database agent 132 as separate agents. It should also be noted that it is not necessary to execute the braking action prediction/alert/warning agent 125 and the database agent 132 simultaneously nor is it necessary to execute the two agents on the same one or more computers 130.

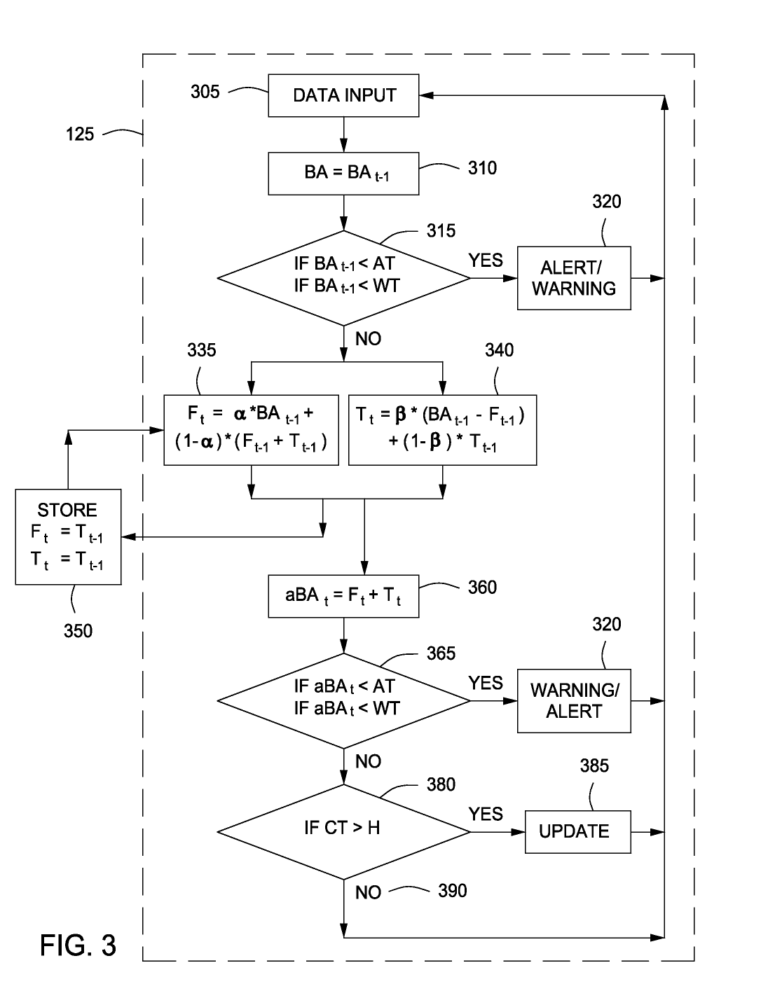

FIG. 3 depicts an illustrative flow diagram for predicting one or more braking action values and assessing alert and/or warning conditions for airport runways, according to one or more embodiments. The braking action prediction/alert/warning agent 125 can commence upon receipt of one or more telemetry inputs 305 that can arrive intermittently, but can also arrive continuously and/or simultaneously over multiple input channels. For example, a first telemetry input from a first aircraft can arrive simultaneously to a second telemetry input from a second aircraft. The one or more telemetry inputs 305 can be associated with one or more aircraft braking action values from aircraft that have landed at the same airport and/or on the same airport runway. The one or more telemetry inputs 305 can be from aircraft from two or more airports and can be sorted to group together the one or more telemetry inputs 305 from the same airport and/or airport runway. The one or more telemetry inputs 305 can be analyzed to determine aircraft braking action values and/or can be used to calculate aircraft braking action values. In one or more embodiments, the one or more telemetry inputs 305 can be g-force read outs and/or deceleration data from one or more aircraft. The g-force data and/or deceleration data can be analyzed as a function of time during landing to find the aircraft braking action value for each particular aircraft landing that the one or more telemetry inputs 305 can be associated with. The one or more telemetry inputs 305 can be the recorded data stream of an aircraft during landing plus the associated weather and/or environmental factors present during the landing. The one or more telemetry inputs 305 can be used to calculate, using known methods, the aircraft braking action value for each particular aircraft landing that the one or more telemetry inputs 305 can be associated with. For example, a first aircraft braking action value can be determined for a first aircraft on a first airport runway and a second aircraft braking action value can be determined for a second aircraft on the first airport runway.

As described by equation (1) below, the incoming braking action “BA” values can be associated with time and the latest braking action value for a given airport and/or airport runway can be defined as the latest historic data “BAₜ₋₁” 310 for use in the forecasting model for the given airport and/or airport runway.

BA=BAₜ₋₁ (1)

The braking action, BA, can be compared 315 to a braking action alert threshold “AT” or warning threshold “WT”, as depicted in equations (2) and (3), respectively:

BAₜ₋₁<AT (2)

BAₜ₋₁<WT (3)

The alert and warning threshold can be associated with braking action values having units of g-force (g). An aircraft manufacturer such as Boeing and/or Airbus typically defines various levels of braking action into certain numeric thresholds that can be in or can be converted into gravitation force or g-force values. In selecting alert and/or warning thresholds, the values of these thresholds can be associated with the general aeronautical terms of braking action such as “poor” and “medium” respectively. If the latest historic breaking action BAₜ₋₁ value is less than the alert threshold or the warning threshold, the alert and/or warning condition can be transmitted 320 to notify users of a “poor” or “medium” runway condition at a given airport and/or on a given runway.

The one or more telemetry inputs 305 can be transformed into a prediction of an expected future braking action value for the given runway. The expected future braking action value can be used to plan for another aircraft's landing on the given runway. In one or more embodiments, the data can be smoothed and trended as part of the prediction. Such a smoothing technique can be applied to time series data, such as braking action from multiple aircraft for a given runway over time, to arrive at a forecast of the expected future runway condition. Runway condition data derived therefrom would be neither random nor erratic but would likely follow the changes in the ambient conditions, such as precipitation, temperature, wind, dew point etc., and the combination of these and/or similar factors. Therefore by the use of smoothed data forecasts of possible changes in conditions can be made that can be further enhanced by incorporating a trend factor to the model. The forecast therefore can include the elements of an unadjusted smoothing component or current adjusted data factor and a trend component or current trend factor. A description of how adjusted braking action forecasts can be generated by using these two elements will be discussed and described below, where the adjusted braking action forecast equals the sum of the current unadjusted data factor and the current trend factor.

To predict future braking action behavior, equations (4) and (5) below can be utilized. A forecasted braking action component 335 of an expected future braking action value or adjusted braking action forecast aBAₜ and a forecasted estimated trend component 340 of the adjusted braking action forecast aBAₜ can be determined utilizing equations (4) and (5), respectively:

Fₜ=α*BAₜ₋₁+(1−α)*(Fₜ₋₁+Tₜ₋₁) (5)

Tₜ=β*(BAₜ₋₁−Fₜ₋₁)(1−β)*Tₜ₋₁) (6)

where Fₜ is the current forecasted braking action component of the adjusted braking action forecast aBAₜ, the braking action component being unadjusted for trend but data smoothed; a (alpha) is a data smoothing factor with a value from 0 to 1, where a value closer to 1 means that a data input will carry more weight in the data smoothing than a value further from 1; BAₜ₋₁ is the braking action value received for a particular aircraft; Fₜ₋₁ is the previous forecasted braking action component unadjusted for trend but data smoothed; Tₜ is the current forecasted estimated trend component of the adjusted braking action forecast aBAₜ; Tₜ₋₁ is the prior forecasted estimated trend component; and p is a trend smoothing factor with a value from 0 to 1, where a value closer to 1 means that a data input and its associated trend will carry more weight in the trending than a value further form 1. Other time series models can be used with varying degrees of success, for example, autoregressive (AR) models, moving average (MA) models, autoregressive moving average (ARMA) models, autoregressive integrated moving average (ARIMA) models, autoregressive conditional heteroskedasticity (ARCH) models, and generalized autoregressive conditional heteroskedasticity (GARCH) models.

In one or more embodiments, the value for the data smoothing factor “α” (alpha) and the trend smoothing factor “β” (beta) can be determined as a function of the time that has elapsed since the one or more telemetry inputs 305 was generated. The longer the time between the one or more telemetry inputs 305 and the time of the current prediction, the lower the value α and β can be. Selecting a value of “0” would mean no weight on the latest information, while “1” would mean all weight is on the latest information. The smoothing factors α and β can be selected to give the most recent one or more telemetry inputs 305 the greatest weight and/or lessor weight in the prediction determination.

In one or more embodiments, the assigned values for α and β can be the same or different. The values for α and β can be between about 0 and about 0.65, between about 0.1 and about 0.45, between about 0.5 and 1, between about 0.6 and 0.7, between about 0.5 and 0.75, between about 0.65 and 0.85, between about 0.65 and 1, or between about 0.65 and 0.8.

To assign values to α and β, the characteristics of the ambient conditions and how they derive and/or change can be used. In broad terms it is the ambient weather conditions prevailing at the time that can drive α and β. Such changes are typically caused by, but are not limited to, weather fronts moving in an out of geographical areas that can include one or more airport runways. Other environmental factors that can cause quickly changing ambient conditions include, but are not limited to, falling temperatures around the freezing point, and precipitation causing runway contaminants. Runway contaminants is an aeronautical term for anything that can cause deteriorating conditions such as moisture, rain sleet, snow, and/or ice.

Weather changes (not seasonal) can be short term in nature and the selection of the α and β values can emphasize the most recent data inputs by selecting a value above about 0.5. The value 0.5 is a “neutral” dampening factor. The frequency of landings can also be a factor in selecting α and β values. On runways with more frequent landings, e.g., 8-10 per hour or more, the need for dampening old observations is somewhat less, as compared to airports with less frequent landings, e.g., 2-4 landings per hour, where recent observation can be dampened using greater dampening of older observations to emphasize more recent data. For example, for runways with more frequent landings, α and β values for the most recent landing(s) can be selected in the range from about 0.65 to about 0.75. For runways with less frequent landings, α and β values can be selected in the range of from about 0.80 and 0.90 for the most recent landing(s).

At the beginning of a forecasting cycle where no trend is present, the prior forecasted estimated trend component (Fₜ₋₁) value can be set to zero. To calculate the current forecasted braking action component (Fₜ), the latest braking action (BAₜ₋₁) can be multiplied by a first a, and the sum of the prior forecasted estimated trend component (Fₜ₋₁) and the prior forecasted estimated trend component (T₁) can be multiplied by the correction factor (1−α). The outcome of the two operations can be summed to determine the current forecasted braking action component (Fₜ)

To calculate the current forecasted estimated trend component (Tₜ), a similar calculation, as shown in equation (5) above can be conducted. Again, at the beginning of a forecasting cycle, the prior forecasted estimated trend component (Tₜ₋₁) value can be set to zero. Here, to calculate the current forecasted estimated trend component (Tₜ), the difference between the latest braking action (BAₜ₋₁) and the prior forecasted estimated trend component (Fₜ₋₁) can be multiplied by a first β. For each successive calculation of the current forecasted braking action component (Fₜ) and the current forecasted estimated trend component (Tₜ), second, third, forth, and subsequent α's and β's can be utilized. The α's and β's can be the same or different for the first, second, third, fourth, and each subsequent calculation. For example, the data smoothing factor α can be a first data smoothing factor α with a first value and can be a second, third, fourth, or nth data smoothing factor α with associated values for subsequent calculations. The trend smoothing factor β can be a first trend smoothing factor β with a first value and can be a second, third, fourth, or nth trend smoothing factor β with associated values for subsequent calculations.

The current adjusted braking action forecast (aBAₜ) can be determined 360 by summing the current forecasted braking action component value (Fₜ) and the current forecasted estimated trend component value (Tₜ). The current forecasted braking action component value (Fₜ) and the current forecasted estimated trend component value (Tₜ) can be stored 350 for future calculations where they can be designated as prior components (Fₜ₋₁) and (Tₜ₋₁). When a new data input is received, the prior components can be utilized to calculate new current forecasted braking action component value (Fₜ) and a new current forecasted estimated trend component value (Tₜ) based upon the smoothing of the data and adjusting the trend as described above.

The current adjusted braking action forecast value (aBAₜ) can be compared to the established warning threshold and alert threshold 365. If the current adjusted forecast is less than the warning threshold, a warning for that airport/runway can be issued 320. For example, the issued warning 320 can be based on the predicted current adjusted braking action forecast value (aBAₜ). If the current adjusted forecast is less than the alert threshold, an alert for that airport/runway can be issued 320. For example, the issued alert 320 can be based on the predicted current adjusted braking action forecast value (aBAₜ).

In at least one embodiments, the value for the adjusted braking action forecast value (aBAₜ) can be updated 385 either manually or automatically. The update 385 can be observation dependent and/or time dependent. For example, if an airport controller observes that the airport conditions are dry, the adjusted braking action forecast value (aBAₜ) can be set to greater than the warning threshold, where the warning threshold is higher than the alert threshold, to “reset” the airport runway for normal operations. In one or more embodiments, the update 385 can be set based on elapsed time since the last braking action data input has been received. If the elapsed time is greater than a predefined update threshold “H” 380, an update 385 to the adjusted braking action forecast value (aBAₜ) can be sent. A numeric value can be issued in conjunction with the general terms for describing braking action in aeronautical terms: Dry, Good, Medium, and Poor. For example, the adjusted braking action forecast value (aBAₜ) can be set to greater than the warning threshold to “reset” the airport runway for normal operations. If the elapsed time is less than the predefined update threshold “H” 390, no action can be taken. In one or more embodiments, the adjusted braking action forecast value (aBAₜ) can be manually set to less than the warning threshold or the alert threshold depending on controller or user observations.

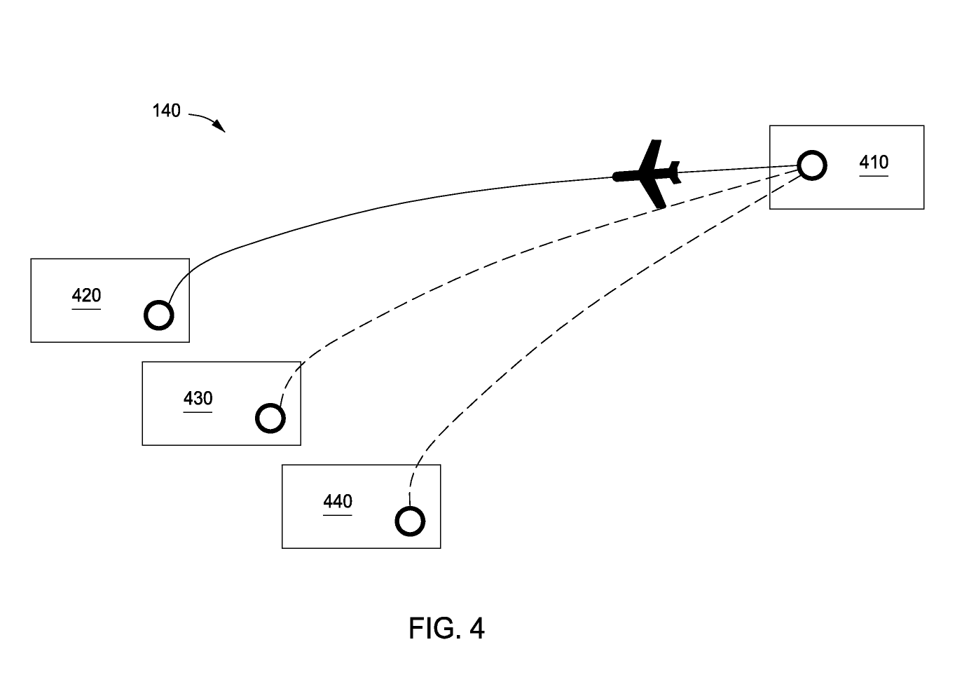

FIG. 4 depicts a schematic 140 of an illustrative flight landing-plan for an aircraft in flight, according to one or more embodiments. Part of flight planning often involves the identification of one or more airports 430, 440 which can be flown to in case of unexpected conditions (such as weather) at the destination airport 420. The planning process can include identifying alternate airports that can be reached with the anticipated fuel load and total aircraft weight of the aircraft in flight and that have capabilities necessary to handle the type of aircraft being flown.

Larger airline operators typically use a centralized dispatch, meaning they have ground based personnel to perform a substantial part of the flight planning and preparatory work before a flight, as well as to monitor flights en route from an origin airport 410 to a destination airport 420. Part of the monitoring is to make sure that weather conditions are not prohibitive at the destination airport 420 as well as at an alternate airport 430. Should either incur weather conditions, for example a designated landing runway becoming too slippery, flight operations can divert or find a new alternate airport 440. The monitoring can include the use of computer systems that can display flight information for the dispatchers.

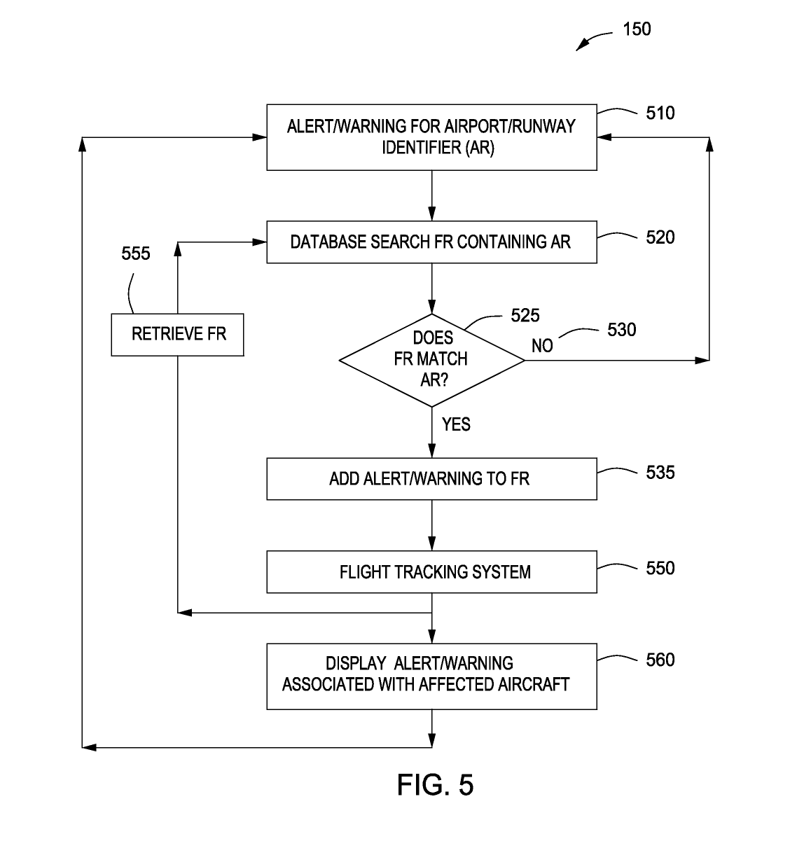

FIG. 5 depicts an illustrative flow diagram 150 for aircraft landing, planning, and decision, according to one or more embodiments. In the event there are several flights with the same destination and/or alternate airports, the illustrative flow diagram can be used for all active flights in the system. Alert and/or warning inputs for a given airport can be received as alerts and/or warnings from specific runways with particular airport/runway identifiers (ARs) 510. A database search can be performed 520 to find flight records (FR) 555 of flights that have not landed. The airport runway identifier (AR) with an alert or warning condition can be compared to the flight records to determine if the designated landing destination airport or alternate airport for the associated aircraft is an airport with the alert or warning condition. If the airport with the alert or warning condition is not the planned landing location for the aircraft 530, no action is required. If the airport with the alert or warning condition is one of the planned landing locations for the aircraft the alert or warning condition information can added to one or more fields in the flight record 535 to update the aircraft's flight record 540. The related flight record and alert/warning can be entered into a flight tracking system 550 and an alert or warning associated with the aircraft can be selectively transmitted to and selectively displayed 560 to operators, dispatchers, controllers, or the like.

The alert or warning associated with the aircraft can be selectively transmitted and displayed in any combination. For example, the alert or warning associated with the aircraft can be transmitted to one or more of the operators, dispatchers, controllers, or the like. The alert or warning associated with the aircraft can be displayed to one or more of the operators, dispatchers, controllers, or the like. The alert or warning associated with the aircraft can be transmitted to every operator, dispatcher, controller, and the like and only displayed to those operators, dispatchers, controllers, and the like having control of or responsibility for the aircraft associated with the alert or warning.

There are several options for communicating the alert and/or warning conditions. Graphical user interfaces (GUI) and user applications can be used with one or more electronic displays. For example, a flight plan/tracking display system can be used by airlines with central dispatch functions, the application can track/monitor a certain number of flights. The GUI/user application can then further sort the pertinent information into relevant airports, being only those defined by flights in the tracking system. In one or more embodiments, airport pertinent information such as alerts and warnings can be tagged to flights with their destination and alternate airports and can provide manual and/or automatic notifications. Other communication devices can include on-board systems such as Electronic Flight Bags (EFB) and Aircraft Communication Addressing and Reporting System (ACARS). The GUI/user application can also come in the form of on-board wireless communication devices such as a smart phone, iPad, tablet, laptop, etc. Applications can be resident on the wireless communication devices that can be used to display representations of one or several airports to which the given aircraft are then scheduled for landing. The communication devices can receive pertinent information such as alerts or warnings. Receipt can be in real or near-real time depending on transmission delays.

In one or more embodiments, each aircraft icon can be an electronic representation of a particular flight and can be “tagged” to the airport/runway alert and/or warning that the associated aircraft is then currently scheduled to utilize. The alert or warning condition can be selectively displayed in proximity to the electronic representation of one or more aircraft that are then designated for landing on the airport runway. In practical terms, this means that any airport/runway information can be passed on to and directed to the flights containing this airport/runway as a destination or alternate airport in its flight plan. By selectively providing to operators, dispatchers, pilots, and/or controllers pertinent information about the airport/runway conditions and associating the information only with the aircraft that are then designated to utilize or potentially utilize as an alternative the given airport/runway, the amount of data the operators, dispatchers, pilots, and/or controllers are subjected to can be reduced. In other words, the data provided to the operators, dispatchers, pilots, and/or controllers can be limited to only the information associated with the aircraft they are tracking, reducing potentially distracting information related to other airports/runways.

The operators, dispatchers, pilots, and/or controllers can be provided with notices only when conditions are or become medium or poor. Pop-up notices, a change of color, and/or an alert sound can be used to indicate a change in conditions at an airport/runway that the given aircraft is then currently scheduled to utilize. The condition changes can be displayed in real or near-real time. In this way, the operators, dispatchers, pilots, and/or controllers can avoid searching for condition changes at airports of interest. This means the dispatcher can have quick and timely information that puts him/her in a position to act earlier, and thereby make more informed and likely better decisions.

Today, as described with the central dispatch function of larger airlines, the dispatcher communicates with pilots via radio or some type of audio/data/text transfer. In one or more embodiments, the communication of runway conditions can take place using any known method to any known device. For example, any type of user application can be installed on a hand held or other wireless display system/device (smart phone, iPad, tablet, laptop computer, etc.) and can be used by pilots and other users for communications. The airport/runway information and/or alert and warning notification can be sent to one or more flight deck devices such as an Aircraft Communication Addressing and Reporting System (ACARS), an Electronic Flight Bag (EFB), an enunciation device, or other graphic or text based display on the flight deck. The airport/runway information can be transmitted to a computer monitor displaying a software tool that can selectively associate and display the alert and/or warning for the airport runway with at least one aircraft that is then designated for landing on the airport runway. Airline operators with lesser presence in one region can draw upon the presence of another airline with flights in the region to provide more information than would otherwise be available without cross region and/or cross operator utilization.

The airport/runway information can be forwarded or pushed to the operators, dispatchers, pilots, and/or controllers. The system can allow one or more operators, dispatchers, pilots, and/or controllers to “pull” desired information on demand. In general, a support and decision tool can be provided to airline operators, dispatchers, pilots, and/or controllers to streamline planning operations as well as to improve flight safety by avoiding problems before they occur by improving information management of crucial information associated with aircraft operations.

Braking action information can be used to automatically determine alert or warning conditions on airport runways. Information can be nearly continuous providing near to real time information for the airports covered in the network. Only pertinent information that requires attention, follow up, and/or decisions by operators, dispatchers, pilots, and/or controllers can be transmitted, reducing data overload to the operators, dispatchers, pilots, and/or controllers. Airline operators, dispatchers, pilots, and/or controllers can have access to pertinent information earlier than otherwise available using today's available systems and methods, thus making better planning possible and providing improved decision making capabilities that can improve operational efficiency. Using aircraft flight data to assess braking action can eliminate runway closures from mechanical measurement devices. More accurate and timely braking action information can reduce landing delays and costly landing diversions.

Embodiments of the present disclosure further relate to any one or more of the following paragraphs:

1. A system for alerting or warning aircraft, including: a first measurement system disposed on a first aircraft, the first measurement system adapted to gather telemetry inputs associated with a braking action value of the first aircraft on an airport runway; a second measurement system disposed on a second aircraft, the second measurement system adapted to gather telemetry inputs associated with a braking action value of the second aircraft on the airport runway; and a computer adapted to receive and sort the telemetry inputs from the first and second aircraft, wherein the computer is adapted to utilize the telemetry inputs to predict an expected future braking action value for a third aircraft scheduled to utilize the airport runway and to selectively transmit, to a communication device, an alert notification if at least one alert threshold is met and a warning notification if at least one warning threshold is met, wherein the computer is adapted to utilize a first data smoothing factor and a first trend smoothing factor to predict the expected future braking action value.

2. The system according to paragraph 1, wherein the computer is adapted to utilize the telemetry data to calculate the braking action value from at least the first aircraft.

The system according to paragraph 1 or 2, wherein the computer is adapted to analyze the telemetry data to find the braking action value for at least the first aircraft.

4. The system according to paragraphs 1 to 3, wherein the communications device is an enunciation device on board a third aircraft's flight deck, the third aircraft being designated for landing on the airport runway.

5. The system according to paragraphs 1 to 4, wherein the communications device is a computer monitor displaying a software tool that selectively associates and displays the alert and warning for the airport runway with at least one aircraft that is then designated for landing on the airport runway.

6. The system according to paragraphs 1 to 5, wherein the communications device is a hand held wireless display system.

7. The system according to paragraphs 1 to 6, wherein the communications device is a display mounted on a third aircraft's flight deck, the third aircraft being then designated for landing on the airport runway.

8. The system according to paragraphs 1 to 7, wherein the communications device is an Electronic Flight Bag (EFB) and/or an Aircraft Communication Addressing and Reporting System on a third aircraft's flight deck, the third aircraft being then designated for landing on the airport runway.

9. The system according to paragraphs 1 to 8, wherein the computer is adapted to selectively associate the alert and/or warning notification with at least one aircraft being then designated for landing at a destination airport or an alternate airport that has an alert and/or warning condition.

10. A method for communication of an airport runway condition, including: comparing a first aircraft braking action value, for an airport runway, determined from a first telemetry input from a first aircraft, to a braking action alert threshold and a braking action warning threshold; selectively transmitting, to a communications device, an alert notification if the first aircraft braking action value meets or exceeds the braking action alert threshold; selectively transmitting, to the communications device, a warning notification if the first aircraft braking action value meets or exceeds the braking action warning threshold; predicting an expected future braking action value for the airport runway based on the first telemetry input from the first aircraft and a second telemetry input from a second aircraft; selectively transmitting the alert notification to the communications device if the expected future braking action value meets or exceeds the braking action alert threshold; and selectively transmitting the warning notification to the communications device if the expected future braking action value meets or exceeds the braking action warning threshold.

11. The method according to paragraph 10, wherein: predicting the expected future braking action value includes, applying a first data smoothing factor to the first aircraft braking action value to generate a first forecasted braking action component value, applying a first trend smoothing factor to the first aircraft braking action value to generate a first forecasted estimated trend component, and calculating the expected future braking action value by summing the first forecasted braking action component value and the first forecasted estimated trend component.

12. The method according to paragraph 10 and 11, wherein: the first data smoothing factor has a value of from about 0 and about 1, and the first trend smoothing factor has a value of from about 0 and about 1,

13. The method according to paragraphs 10 to 12, including: searching one or more flight records for one or more destination airports and/or one or more alternate airports for a match between the one or more flight records and alert or warning notifications associated with a runway identifier; selecting at least one flight record containing a match between a destination airport and/or an alternate airport, and the runway identifier; updating the selected at least one flight record with an alert and/or warning notification in a field of the flight record; selectively transmitting the updated flight record containing an alert or warning notification to a user application; displaying the alert or warning notification to at least one user; and selectively associating the alert and/or warning notification with at least one aircraft having then planned landings at the destination and/or the alternate airports that have alert or warning conditions.

14. The method according to paragraphs 10 to 13, wherein the alert or warning condition is displayed only in proximity to an electronic representation of one or more aircraft that are then designated for landing on the destination and/or the alternate airports that have alert or warning conditions.

15. A method for an aircraft operational monitoring system, including: searching one or more flight records for one or more destination airports and one or more alert or warning notifications associated with one or more runway identifiers; selecting one or more flight records containing a match between the destination airport and the one or more runway identifiers; updating the selected one or more flight records with an alert or warning notification in a field of each of the selected one or more flight records; transmitting one or more updated selected flight records to a user application; and selectively displaying the alert or warning notification to users by associating the alert or warning notification with aircraft having planned landings at the destination airport.

16. The method according to paragraph 15, including: searching the one or more flight records for one or more alternate airports and one or more alert or warning notifications associated with the one or more runway identifiers; selecting one or more flight records containing a match between the one or more alternate airports and the one or more runway identifiers; updating the selected one or more flight records containing a match between the one or more alternate airports and the one or more runway identifiers with an alert or warning notification in a field of each of the selected one or more flight records containing a match between the one or more alternate airports and the one or more runway identifiers; transmitting the updated one or more updated flight records containing a match between the one or more alternate airports and the one or more runway identifiers to the user application; and selectively displaying the alert or warning notification to users by associating the alert or warning notification with aircraft having planned landings at the one or more alternate airports.

17. The method according to paragraphs 15 and 16, wherein selectively displaying the alert or warning notification includes a pop-up window appearing in a screen on a monitor of a user application in combination with sound from the user application.

18. The method according to paragraphs 15 to 17, wherein selectively displaying the alert or warning notification includes a change of color of a symbol illustrating a aircraft on a display system.

19. The method according to paragraphs 15 to 18, wherein selectively displaying the alert or warning notification includes a change of color of the symbol illustrating the aircraft in a display system in combination with sound from a user application.

20. The method according to paragraphs 15 to 19, wherein selectively displaying the alert or warning notification includes a pop-up window appearing in a screen on a communications device.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention can be devised without departing from the basic scope thereof, and the scope thereof is determined by the claims that follow.

What is claimed is:

1. A system for alerting or warning aircraft, comprising:
a first measurement system disposed on a first aircraft, the first measurement system adapted to gather telemetry inputs associated with a braking action value of the first aircraft on an airport runway;
a second measurement system disposed on a second aircraft, the second measurement system adapted to gather telemetry inputs associated with a braking action value of the second aircraft on the airport runway; and
a computer adapted to receive and sort the telemetry inputs from the first and second aircraft, wherein the computer is adapted to utilize the telemetry inputs to predict an expected future braking action value for a third aircraft scheduled to utilize the airport runway and to selectively transmit, to a communication device, an alert notification if at least one alert threshold is met and a warning notification if at least one warning threshold is met,
wherein the computer is adapted to utilize a first data smoothing factor and a first trend smoothing factor to predict the expected future braking action value.

2. The system of claim 1, wherein the computer is adapted to utilize the telemetry data to calculate the braking action value from at least the first aircraft.

3. The system of claim 1, wherein the computer is adapted to analyze the telemetry data to find the braking action value for at least the first aircraft.

4. The system of claim 1, wherein the communications device is an enunciation device on board a third aircraft's flight deck, the third aircraft being designated for landing on the airport runway.

5. The system of claim 1, wherein the communications device is a computer monitor displaying a software tool that selectively associates and displays the alert and warning for the airport runway with at least one aircraft that is then designated for landing on the airport runway.

6. The system of claim 1, wherein the communications device is a hand held wireless display system.

7. The system of claim 1, wherein the communications device is a display mounted on a third aircraft's flight deck, the third aircraft being then designated for landing on the airport runway.

8. The system of claim 1, wherein the communications device is an Electronic Flight Bag (EFB) and/or an Aircraft Communication Addressing and Reporting System on a third aircraft's flight deck, the third aircraft being then designated for landing on the airport runway.

9. The system of claim 1, wherein the computer is adapted to selectively associate the alert and/or warning notification with at least one aircraft being then designated for landing at a destination airport or an alternate airport that has an alert and/or warning condition.

10. A method for communication of an airport runway condition, comprising:
comparing a first aircraft braking action value, for an airport runway, determined from a first telemetry input from a first aircraft, to a braking action alert threshold and a braking action warning threshold;
selectively transmitting, to a communications device, an alert notification if the first aircraft braking action value meets or exceeds the braking action alert threshold;
selectively transmitting, to the communications device, a warning notification if the first aircraft braking action value meets or exceeds the braking action warning threshold;
predicting an expected future braking action value for the airport runway based on the first telemetry input from the first aircraft and a second telemetry input from a second aircraft;
selectively transmitting the alert notification to the communications device if the expected future braking action value meets or exceeds the braking action alert threshold; and
selectively transmitting the warning notification to the communications device if the expected future braking action value meets or exceeds the braking action warning threshold.

11. The method of claim 10, wherein:
predicting the expected future braking action value comprises,
applying a first data smoothing factor to the first aircraft braking action value to generate a first forecasted braking action component value,
applying a first trend smoothing factor to the first aircraft braking action value to generate a first forecasted estimated trend component, and
calculating the expected future braking action value by summing the first forecasted braking action component value and the first forecasted estimated trend component.

12. The method of claim 11, wherein:
the first data smoothing factor has a value of from about 0 and about 1, and
the first trend smoothing factor has a value of from about 0 and about 1,

13. The method of claim 10, comprising:
searching one or more flight records for one or more destination airports and/or one or more alternate airports for a match between the one or more flight records and alert or warning notifications associated with a runway identifier;
selecting at least one flight record containing a match between a destination airport and/or an alternate airport, and the runway identifier;
updating the selected at least one flight record with an alert and/or warning notification in a field of the flight record;
selectively transmitting the updated flight record containing an alert or warning notification to a user application;
displaying the alert or warning notification to at least one user; and
selectively associating the alert and/or warning notification with at least one aircraft having then planned landings at the destination and/or the alternate airports that have alert or warning conditions.

14. The method of claim 13, wherein the alert or warning condition is displayed only in proximity to an electronic representation of one or more aircraft that are then designated for landing on the destination and/or the alternate airports that have alert or warning conditions.

15. A method for an aircraft operational monitoring system, comprising:
searching one or more flight records for one or more destination airports and one or more alert or warning notifications associated with one or more runway identifiers;
selecting one or more flight records containing a match between the destination airport and the one or more runway identifiers;
updating the selected one or more flight records with an alert or warning notification in a field of each of the selected one or more flight records;
transmitting one or more updated selected flight records to a user application; and
selectively displaying the alert or warning notification to users by associating the alert or yearning notification with aircraft having planned landings at the destination airport.

16. The method of claim 15, comprising:
searching the one or more flight records for one or more alternate airports and one or more alert or warning notifications associated with the one or more runway identifiers;
selecting one or more flight records containing a match between the one or more alternate airports and the one or more runway identifiers;
updating the selected one or more flight records containing a match between the one or more alternate airports and the one or more runway identifiers with an alert or warning notification in a field of each of the selected one or more flight records containing a match between the one or more alternate airports and the one or more runway identifiers;
transmitting the updated one or more updated flight records containing a match between the one or more alternate airports and the one or more runway identifiers to the user application; and
selectively displaying the alert or warning notification to users by associating the alert or warning notification with aircraft having planned landings at the one or more alternate airports.

17. The method of claim 15, wherein selectively displaying the alert or warning notification comprises a pop-up window appearing in a screen on a monitor of a user application in combination with sound from the user application.

18. The method of claim 17, wherein selectively displaying the alert or warning notification comprises a change of color of a symbol illustrating a aircraft on a display system.

19. The method of claim 17, wherein selectively displaying the alert or warning notification comprises a change of color of the symbol illustrating the aircraft in a display system in combination with sound from a user application.

20. The method of claim 17, wherein selectively displaying the alert or warning notification comprises a pop-up window appearing in a screen on a communications device.
